(19) United States
(12) Patent Application Publication
(10) Pub. No.: US 2002/0176053 A1
(43) Pub. Date: Nov. 28, 2002

(54) Three-prism projection display

(76) Inventors: Fu-Ming Chuang, Hsin-Chu Hsien (TW); Han-Wen Tsai, Hsin-Chu Hsien (TW)

Correspondence Address: TROP PRUNER & HU, PC, 8554 KATY FREEWAY, SUITE 100, HOUSTON, TX, 77024, US

(21) Appl. No.: 09/865,391

(22) Filed: May 25, 2001

(51) Int. Cl. G03B 21/14

(52) U.S. Cl. 353/20; 353/33

(57) ABSTRACT

In a three-prism projection display, input light is separated by a polarization beam splitter prism into a first color component, which is received by a first dichroic beam splitter prism and processed by a first light modulator, and second and third color components, which are received by a second dichroic beam splitter prism and processed by second and third light modulators, respectively.

### BACKGROUND OF THE INVENTION

1. Field of the Invention

The invention relates to a projection display, more particularly a three-prism single-lens projection display.

2. Description of the Related Art

Referring to FIGS. 1 and 2, in a conventional single-lens projection display 1, an input light beam 10 from an illuminating apparatus (not shown) of a liquid crystal display is processed before providing the same to a projection lens 11 so as to generate an output image. The light beam 10 is generally white light of a predetermined polarization state, such as S-polarization state, and contains first, second and third color components 101, 102, 103. The projection display 1 includes a first light polarization selector 12, a polarization beam splitter prism 13, a dichroic beam splitter prism 14, a first light modulator 15, a second light modulator 16, a third light modulator 17, a second light polarization selector 18, and a polarizer 19. The first, second and third light modulators 15, 16, 17 are typically reflective light valves.

Each of the first and second light polarization selectors 12, 18, such as the ColorSelect™ filter products available from ColorLink Inc., serves to convert the polarization state of a predetermined color component, without altering the polarization state of the other color components. In the projection display 1 of FIGS. 1 and 2, the polarization state of the third color component 103 is changed from the S-polarization state into a P-polarization state, whereas the current polarization state of the first and second color components 101, 102 remains unaltered, after the color components 101, 102, 103 pass through the first and second light polarization selector 12, 18.

The polarization beam splitter prism 13 receives the S-polarized first and second color components 101, 102 from the first light polarization selector 12 at a first side thereof, and reflects the same in a transverse direction such that the first and second color components 101, 102 pass through a second side thereof. With reference to FIG. 2, due to the P-polarization characteristics of the polarization beam splitter prism 13, a large portion (about 90%) of the P-polarized third color component 103 from the first light polarization selector 12 will pass through a third side of the polarization beam splitter prism 13 opposite to the first side. A small portion (about 10%) of the third color component 103 will, however, be reflected by the polarization beam splitter prism 13 to pass through the second side thereof, thus resulting in a light leakage component 106. The dichroic beam splitter prism 14 is disposed adjacent to the second side of the polarization beam splitter prism 13, and receives the first and second color components 101, 102 and the light leakage component 106 therefrom. As shown in FIG. 1, the first color component 101 passes directly through the dichroic beam splitter prism 14, whereas the second color component 102 is reflected by the dichroic beam splitter prism 14 in a transverse direction.

The first and second light modulators 15, 16 are disposed adjacent to the dichroic beam splitter prism 14 so as to receive the first and second color components 101,102 therefrom. The first and second light modulators 15, 16 respectively modulate the first and second color components 101, 102 and change the polarization state of the corresponding first or second color component 101, 102 from the S-polarization state to the P-polarization state when the first and second light modulators 15, 16 are activated. The first and second light modulators 15, 16 reflect the corresponding color component back to the dichroic beam splitter prism 14 for reception by the polarization beam splitter prism 13.

Due to the P-polarization characteristics of the polarization beam splitter prism 13, a large portion (about 90%) of the reflected first and second color components 101, 102 will pass through a fourth side of the polarization beam splitter prism 13 opposite to the second side, and through the second light polarization selector 18 before reaching the polarizer 19. A small portion (about 10%) of the reflected first and second color components 101, 102 will, however, be directed by the polarization beam splitter 13 to pass through the first side thereof, i.e. toward the first light polarization selector 12, thus resulting in light leakage components 104, 105.

Referring once again to FIG. 2, the third light modulator 17 is disposed adjacent to the third side of the polarization beam splitter prism 13 so as to receive the third light component 103 therefrom. The third light modulator 17 modulates the third color component 103, and changes the polarization state of the third color component 103 from the P-polarization state to the S-polarization state when the third light modulator 17 is activated. The third light modulator 17 reflects the third color component 103 back to the polarization beam splitter prism 13. The reflected S-polarized third color component 103 is then directed by the polarization beam splitter prism 13 so as to pass through the fourth side thereof for reception by the second light polarization selector 18, thereby changing the polarization state thereof from the S-polarization state back to the P-polarization state before the reflected third color component 103 reaches the polarizer 19.

The polarizer 19 permits only pure P-polarized color components to pass therethrough, and absorbs S-polarized color components. The first, second and third color components 101, 102, 103 from the polarizer 19 are recombined as they pass through the projection lens 11 for projecting a color image on a display screen (not shown).

As shown in FIG. 1, because the light leakage components 104, 105 associated with the first and second color components 101, 102 do not reach the projection lens 11, the quality of the output image from the projection lens 11 will not be adversely affected thereby. However, with reference to FIG. 2, the light leakage component 106 that is associated with the third color component 103 and that is directed by the polarization beam splitter prism 13 to pass through the second side thereof, i.e. toward the dichroic beam splitter prism 14, might be provided to one of the first and second light modulators 15, 16, where it can undesirably combine with one of the first and second color components 101, 102. Since the polarizer 19 of the projection display 1 is only capable of absorbing light of a predetermined polarization state, in this case—the S-polarization state, the polarizer 19 will be unable to absorb the P-polarized light leakage component 106. As such, the light leakage component 106 will reach the projection lens 11 and will reduce the contrast and quality of the output image from the projection lens 11.

Moreover, when the third light modulator 17 is deactivated, such as when the third color component 103 is not required in the output image from the projection lens 11, in view of the P-polarization characteristics of the polarization beam splitter prism 13, a small portion (about 10%) of the P-polarized third color component 103 will be reflected by the polarization beam splitter prism 13 to pass through the fourth side thereof, i.e. toward the projection lens 11, thereby resulting in a light leakage component 107, as best shown in FIG. 2. Likewise, as the polarizer 19 of the projection display 1 is unable to absorb the P-polarized light leakage component 107, the light leakage component 107 will reach the projection lens 11 such that a weak yet noticeable portion of the third color component 103 will be undesirably introduced into the output image from the projection lens 11.

### SUMMARY OF THE INVENTION

Therefore, the main object of the present invention is to provide a three-prism projection display capable of overcoming the aforesaid drawbacks of the prior art to enhance both contrast and output image quality.

According to the present invention, a three-prism projection display is adapted to process an input light beam and to provide an output light beam to a projection lens. The input light beam includes a first color component, a second color component and a third color component, each of which has a first polarization state. The three-prism projection display comprises:

a polarization state converting device adapted to receive the input light beam and to convert the polarization state of the first color component from the first polarization state to a second polarization state different from the first polarization state;

a polarization beam splitter prism having a first side to be disposed adjacent to the projection lens, a second side disposed adjacent to the polarization state converting device, a third side opposite to the first side, and a fourth side opposite to the second side, the polarization beam splitter prism receiving the input light beam from the polarization state converting device at the second side thereof, and separating the input light beam into the first color component, which passes through the third side thereof, and the second and third color components, which pass through the fourth side thereof;

a first dichroic beam splitter prism disposed adjacent to the third side of the polarization beam splitter prism, the first dichroic beam splitter prism permitting the first color component from the polarization beam splitter prism to pass therethrough;

a first light modulator disposed adjacent to the first dichroic beam splitter prism so as to receive the first color component therefrom, the first light modulator modulating the first color component and changing the polarization state of the first color component back to the first polarization state when activated, the first light modulator reflecting the first color component back to the first dichroic beam splitter prism;

a second dichroic beam splitter prism having a first surface disposed adjacent to the fourth side of the prolarization beam splitter prism, a second surface opposite to the first surface, and a third surface between the first and second surfaces, the second dichroic beam splitter prism permitting the second color component from the polarization beam splitter prism to pass through the second surface thereof, and reflecting the third color component from the polarization beam splitter prism in a transverse direction so as to pass through the third surface thereof;

a second light modulator disposed adjacent to the second surface of the second dichroic beam splitter prism so as to receive the second color component therefrom, the second light modulator modulating the second color component and changing the polarization state of the second color component to the second polarization state when activated, the second light modulator reflecting the second color component back to the second dichroic beam splitter prism; and

a third light modulator disposed adjacent to the third surface of the second dichroic beam splitter prism so as to receive the third color component therefrom, the third light modulator modulating the third color component and changing the polarization state of the third color component to the second polarization state when activated, the third light modulator reflecting the third color component back to the second dichroic beam splitter prism.

The polarization beam splitter prism receives from the first dichroic beam splitter prism the first color component reflected by the first light modulator at the third side thereof, and receives from the second dichroic beam splitter prism the second and third color component reflected by the second and third light modulators at the fourth side thereof. A light polarization selector is adapted to be disposed between the first side of the polarization beam splitter prism and the projection lens. The light polarization selector receives the reflected first, second and third color components from the polarization beam splitter prism, and changes the polarization state of the reflected first color component from the first polarization state to the second polarization state.

A polarizer is adapted to be disposed between the light polarization selector and the projection lens, and is adapted to absorb light that has the first polarization state and to permit light that has the second polarization state to pass therethrough.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view to illustrate how S-polarized first and second color components of an input light beam from an illuminating apparatus are processed by a conventional single-lens projection display;

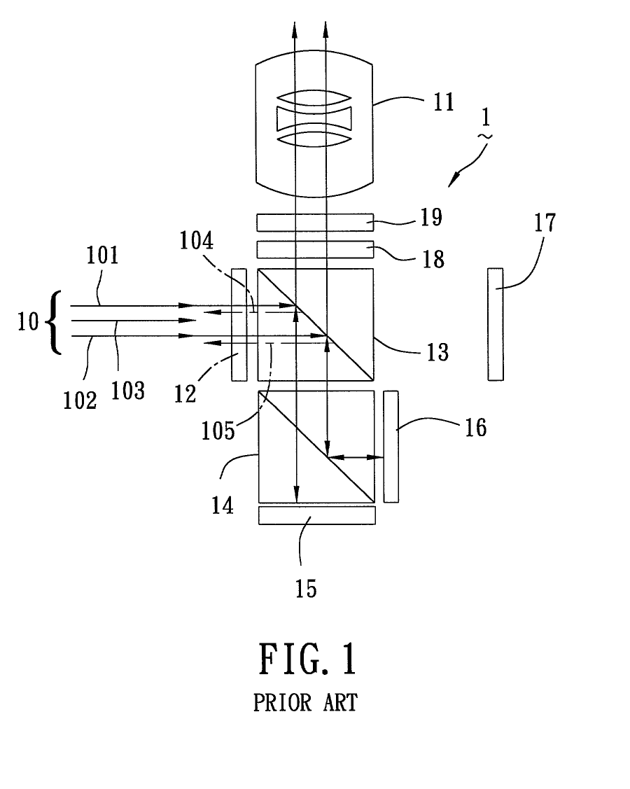

FIG. 2 is a schematic view to illustrate how a P-polarized third color component of the input light beam from the illuminating apparatus is processed by the conventional single-lens projection display;

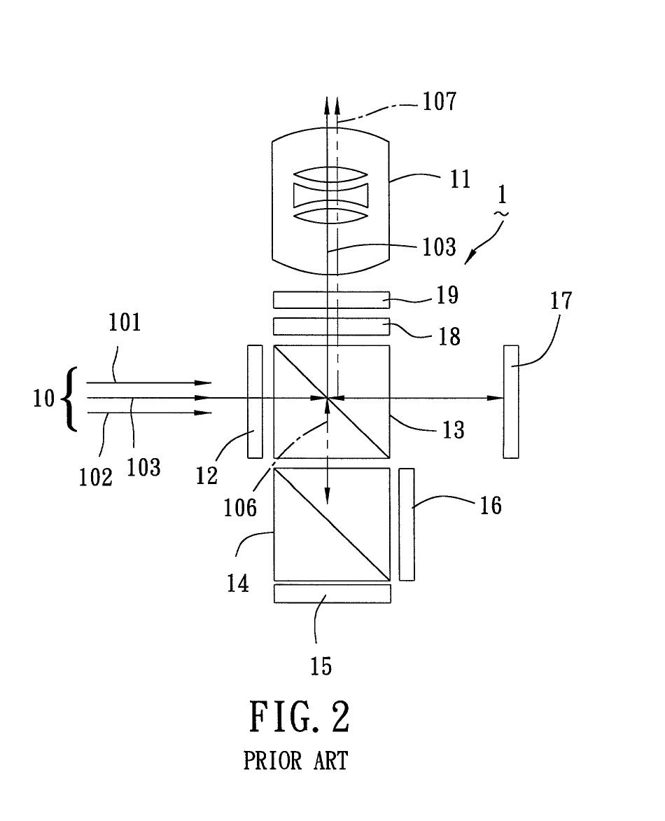

FIG. 3 is a schematic view to illustrate how a first color component of an input light beam from an illuminating apparatus is processed by the preferred embodiment of a three-prism projection display according to the present invention, with a corresponding first light modulator in an activated state; 20

FIG. 4 is a schematic view to illustrate how the first color component of the input light beam is processed by the preferred embodiment, with the corresponding first light modulator in a deactivated state;

FIG. 5 is a schematic view to illustrate how second and third color components of the input light beam from the illuminating apparatus are processed by the preferred embodiment, with corresponding second and third light modulators in an activated state; and

FIG. 6 is a schematic view to illustrate how the second and third color components of the input light beam are processed by the preferred embodiment, with the corresponding second and third light modulators in a deactivated state.

### DETAILED DESCRIPTION OF THE PREFERRED EMBODIMENT

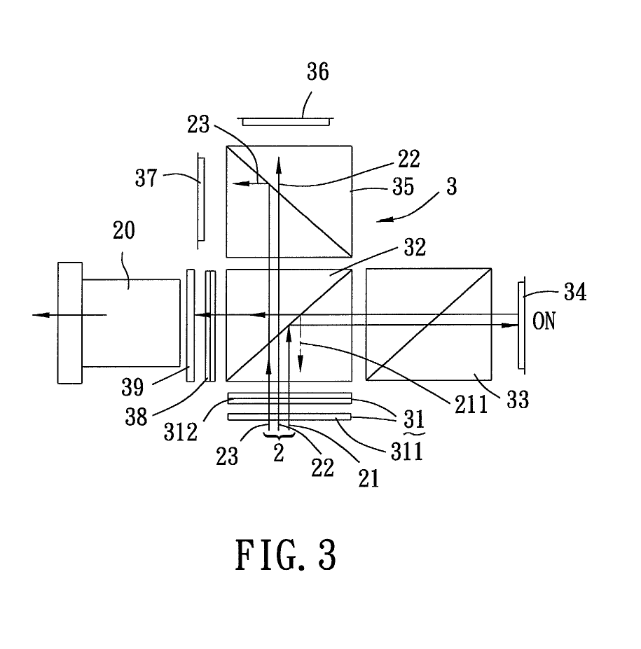

Referring to FIG. 3, in the preferred embodiment of a three-prism projection display 3 according to the present invention, an input light beam 2 from an illuminating apparatus (not shown) is processed in order to provide an output light beam to a projection lens 20 so as to generate an output image. The input light beam 2 is generally white light that contains a first color component 21, a second color component 22, and a third color component 23. In this embodiment, the first, second and third color components 21, 22, 23 are green, red and blue color components, respectively. Moreover, in the preferred embodiment, each of the first, second and third color components 21, 22, 23 has a P-polarization state coming from the illuminating apparatus, and an S-polarization state upon reaching the projection lens 20.

The projection display 3 includes a polarization state converting device 31, a polarization beam splitter prism 32, a first dichroic beam splitter prism 33, a first light modulator 34, a second dichroic beam splitter prism 35, a second light modulator 36, a third light modulator 37, a light polarization selector 38, and a polarizer 39. The first, second and third light modulators 34, 36, 37 are preferably reflective light valves.

The polarization state converting device 31 receives the input light beam 2 and converts the polarization state of the first color component 21 from the first or P-polarization state to the second or S-polarization state. In this embodiment, the polarization state converting device 31 includes a polarizer 311 that absorbs S-polarized light and that permits only pure P-polarized light to pass therethrough, and a light polarization selector 312 for converting the polarization state of the first color component 21 from the P-polarization state to the S-polarization state.

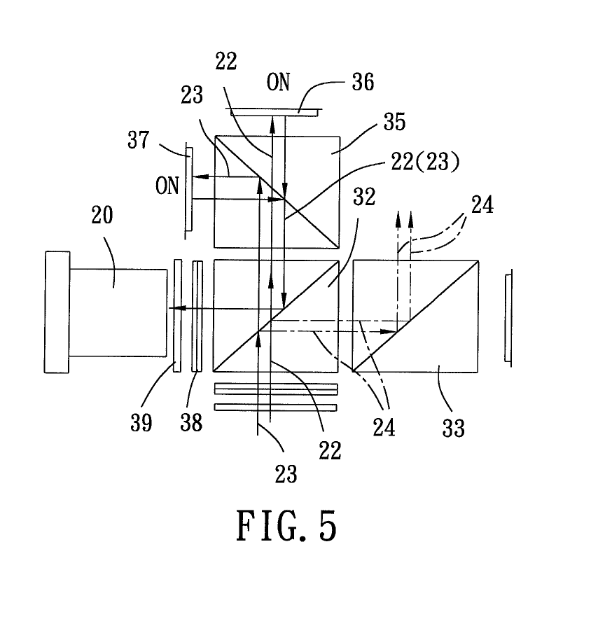

The polarization beam splitter prism 32 has a first side to be disposed adjacent to the projection lens 20, a second side disposed adjacent to the polarization state converting device 31, a third side opposite to the first side, and a fourth side opposite to the second side. The polarization beam splitter prism 32 receives the input light beam from the polarization state converting device 31 at the second side thereof, and separates the input light beam into the S-polarized first color component 21, which is reflected by the polarization beam splitter prism 32 in a transverse direction away from the projection lens 20 so as to pass through the third side thereof, and the P-polarized second and third color components 22, 23. With further reference to FIG. 5, due to the characteristics of the polarization beam splitter prism 32, a large portion (about 90%) of the P-polarized second and third color components 22, 23 will be permitted to pass through the fourth side of the polarization beam splitter prism 32. A small portion (about 10%) of the P-polarized second and third color components 22, 23 will, however, be reflected in a transverse direction, thereby resulting in light leakage components 24 that pass through the third side of the polarization beam splitter prism 32.

Referring again to FIG. 3, the first dichroic beam splitter prism 33, which is disposed adjacent to the third side of the polarization beam splitter prism 32, permits light of a predetermined color to pass therethrough, and reflects light of other colors. In this embodiment, the first dichroic beam splitter prism 33 permits the first color component 21 from the polarization beam splitter prism 32 to pass therethrough, and reflects the light leakage components 24 that are associated with the second and third color components 22, 23 in a transverse direction, thereby preventing the light leakage components 24 from reaching the projection lens 20 and from affecting adversely the contrast and the quality of the output image from the projection lens 20.

The first light modulator 34 is disposed adjacent to the first dichroic beam splitter prism 33 so as to receive the first color component 21 therefrom. The first light modulator 34 modulates the first color component 21 and changes the polarization state of the first color component 21 from the S-polarization state to the P-polarization state when the first light modulator 34 is activated. The first light modulator 34 reflects the first color component 21 back to the first dichroic beam splitter prism 33. Even though the polarization state of the first color component 21 has changed, because the color thereof has not changed, the first color component 21 will be able to pass through the first dichroic beam splitter 33 so as to reach the polarization beam splitter prism 32.

The second dichroic beam splitter prism 35 has a first surface disposed adjacent to the fourth side of the polarization beam splitter prism 32, a second surface opposite to the first surface, and a third surface between the first and second surfaces. The second dichroic beam splitter prism 35 permits light of a predetermined color to pass therethrough, and reflects light of other colors. In this embodiment, the second dichroic beam splitter prism 35 receives the P-polarized second and third color components 22, 23 from the polarization beam splitter prism 32, permits the second color component 22 to pass through the second surface thereof, and reflects the third color component 23 in a transverse direction so as to pass through the third surface thereof.

Referring back to FIG. 5, each of the second and third light modulators 36, 37 is disposed adjacent to a respective one of the second and third surfaces of the second dichroic beam splitter prism 35 so as to receive a corresponding one of the second and third color components 22, 23 therefrom. The second light modulator 36 modulates the second color component 22 and changes the polarization state of the second color component 22 from the P-polarization state to the S-polarization state when the second light modulator 36 is activated. The second light modulator 36 reflects the second color component 22 back to the second dichroic beam splitter prism 35. At this time, all of the reflected S-polarized second color component 22 will pass through the second dichroic beam splitter prism 35 and reach the fourth side of the polarization beam splitter prism 32.

Similarly, the third light modulator 37 modulates the third color component 23 and changes the polarization state of the third color component 23 from the P-polarization state to the S-polarization state when the third light modulator 37 is activated. The third light modulator 37 reflects the third color component 23 back to the second dichroic beam splitter prism 35. At this time, all of the reflected S-polarized third 5 color component 23 will be directed by the second dichroic beam splitter prism 35 to the fourth side of the polarization beam splitter prism 32.

As shown in FIG. 3, in view of the characteristics of the polarization beam splitter prism 32, a large portion (about 90%) of the P-polarized reflected first color component 21 that was reflected by the first light modulator 34 and that was received by the polarization beam splitter prism 32 from the first dichroic beam splitter prism 33 will be allowed to pass through the first side of the polarization beam splitter prism 32. A small portion (about 10%) of the P-polarized reflected first color component 21 will, however, be reflected by the polarization beam splitter prism 32 in a transverse direction to pass through the second side thereof, i.e. toward the polarization state converting device 31, thereby resulting in a light leakage component 211. The light leakage component 211 that is associated with the first color component 21 is thus prevented from reaching the projection lens 20 and from affecting adversely the contrast and the quality of the output image from the projection lens 20.

The light polarization selector 38, which is disposed between the first side of the polarization beam splitter prism 32 and the projection lens 20, receives the reflected first, second and third color components 21, 22, 23 from the polarization beam splitter prism 32, and changes the polarization state of the reflected first color component 21 from the P-polarization state back to the S-polarization state before the reflected first color component 21 reaches the projection lens 20.

The polarizer 39, which is disposed between the light polarization selector 38 and the projection lens 20, permits only pure S-polarized color components to pass therethrough, and absorbs P-polarized color components. The S-polarized first, second and third color components 21, 22, 23 from the polarizer 39 are recombined as they pass through the projection lens 20 for projecting a color image on a display screen (not shown).

Preferably, a quarter-wavelength plate (not shown) can be disposed between each of the first, second and third light modulators 34, 36, 37 and the adjacent one of the first and second dichroic beam splitter prisms 33, 35 for improved contrast.

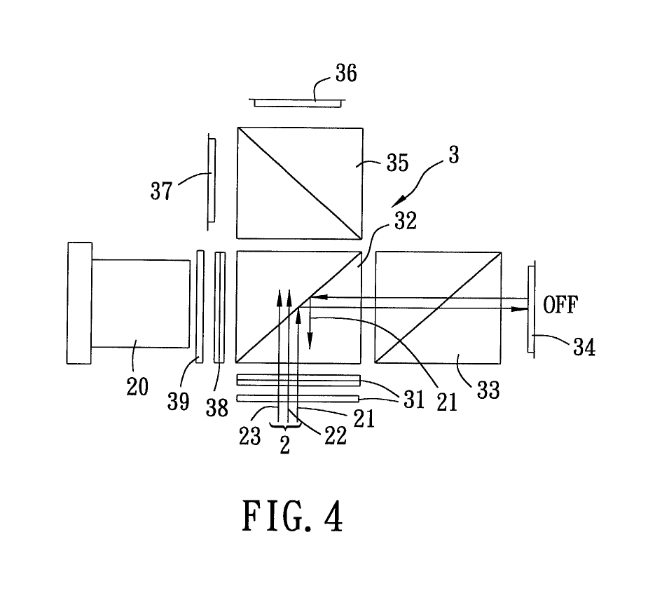

Referring to FIG. 4, when the first light modulator 34 is deactivated, the first color component 21 will be reflected back to the first dichroic beam splitter prism 33 without altering its polarization state. The S-polarized first color component 21 will then pass through the first dichroic beam splitter 33 and reach the polarization beam splitter prism 32. The S-polarized first color component 21 will subsequently be reflected by the polarization beam splitter prism 32 to pass through the second side thereof, i.e. toward the polarizationstateconvertingdevice31, so as to prevent the S-polarized first color component 21 from reaching the projection lens 20 and from affecting the output image from the projection lens 20.

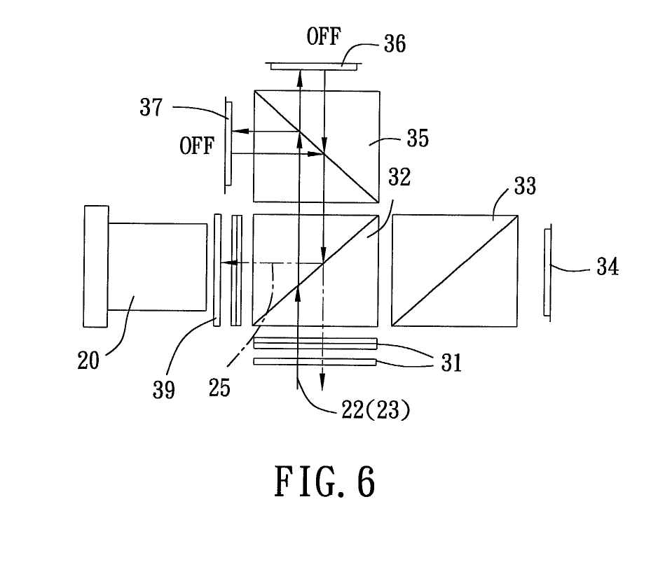

Referring to FIG. 6, when the second light modulator 36 is deactivated, the P-polarized second color component 22 from the second dichroic beam splitter prism 35 will be reflected back to the same so as to reach the polarization beam splitter 32 without altering the polarization state of the second color component 22. In view of the characteristics of the polarization beam splitter prism 32, a large portion (about 90%) of the P-polarized second color component 22 from the second dichroic beam splitter prism 35 will be allowed to pass through the second side of the polarization beam splitter prism 32, i.e. toward the polarization state converting device 31, so as to be prevented from reaching the projection lens 20 and from thus affecting adversely the contrast and the quality of the output image from the projection lens 20. A small portion (about 10%) of the P-polarized second color component 22 from the second dichroic beam splitter prism 35 will, however, be reflected by the polarization beam splitter prism 32 in a transverse direction to pass through the first side thereof, i.e. toward the projection lens 20, to form a light leakage component 25. Because the polarizer 39 is disposed between the polarization beam splitter prism 32 and the projection lens 20, the P-polarized light leakage component 25 will be absorbed by the polarizer 39, thereby preventing the light leakage component 25 that is associated with the second color component 22 from reaching the projection lens 20 and from affecting the output image from the projection lens 20.

Similarly, when the third light modulator 37 is deactivated, the P-polarized third color component 23 from the second dichroic beam splitter prism 35 will be reflected back to the same so as to reach the polarization beam splitter 32 without altering the polarization state of the third color component 23. Thereafter, a large portion (about 90%) of the P-polarized third color component 23 from the second dichroic beam splitter prism 35 will be allowed to pass through the second side of the polarization beam splitter prism 32, i.e. toward the polarization state converting device 31, so as to be prevented from reaching the projection lens 20. A small portion (about 10%) of the P-polarized third color component 23 from the second dichroic beam splitter prism 35 will be reflected by the polarization beam splitter prism 32 in a transverse direction to pass through the first side thereof, i.e. toward the projection lens 20, to form the P-polarized light leakage component 25 that will be absorbed by the polarizer 39.

It has thus been shown that, by virtue of the polarization beam splitter prism 32 and the first and second dichroic beam splitter prisms 33, 35 in the projectiondisplay3ofthisinvention, the light leakage components 211, 24 that are associated with the first, second and third color components 21, 22, 23 and that are generated when the corresponding first, second and third light modulators 34, 36, 37 are activated can be prevented from reaching the projection lens 20 so as not to adversely affect the output image from the projection lens 20. Moreover, since activation of the first, second and third light modulators 34, 36, 37 depends upon the colors to be projected by the projection display 3 of this invention on the display screen (not shown), the color component that is associated with the deactivated one of the light modulators 34, 36, 37 will be either directed away from the projection lens 20 or absorbed by the polarizer 39, thereby resulting in an enhanced output image quality from the projection lens 20.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A three-prism projection display adapted to process an input light beam and to provide an output light beam to a projection lens, the input light beam including a first color component, a second color component and a third color component, each of which has a first polarization state, said three-prism projection display comprising:
a polarization state converting device adapted to receive the input light beam and to convert the polarization state of the first color component from the first polarization state to a second polarization state different from the first polarization state;
a polarization beam splitter prism having a first side to be disposed adjacent to the projection lens, a second side disposed adjacent to said polarization state converting device, a third side opposite to said first side, and a fourth side opposite to said second side, said polarization beam splitter prism receiving the input light beam from said polarization state converting device at said second side thereof, and separating the input light beam into the first color component, which passes through said third side thereof, and the second and third color components, which pass through said fourth side thereof;
a first dichroic beam splitter prism disposed adjacent to said third side of said polarization beam splitter prism, said first dichroic beam splitter prism permitting the first color component from said polarization beam splitter prism to pass therethrough;
a first light modulator disposed adjacent to said first dichroic beam splitter prism so as to receive the first color component therefrom, said first light modulator modulating the first color component and changing the polarization state of the first color component back to the first polarization state when activated, said first light modulator reflecting the first color component back to said first dichroic beam splitter prism;
a second dichroic beam splitter prism having a first surface disposed adjacent to said fourth side of said prolarization beam splitter prism, a second surface opposite to said first surface, and a third surface between said first and second surfaces, said second dichroic beam splitter prism permitting the second color component from said polarization beam splitter prism to pass through said second surface thereof, and reflecting the third color component from said polarization beam splitter prism in a transverse direction so as to pass through said third surface thereof;
a second light modulator disposed adjacent to said second surface of said second dichroic beam splitter prism so as to receive the second color component therefrom, said second light modulator modulating the second color component and changing the polarization state of the second color component to the second polarization state when activated, said second light modulator reflecting the second color component back to said second dichroic beam splitter prism; and
a third light modulator disposed adjacent to said third surface of said second dichroic beam splitter prism so as to receive the third color component therefrom, said third light modulator modulating the third color component and changing the polarization state of the third color component to the second polarization state when activated, said third light modulator reflecting the third color component back to said second dichroic beam splitter prism.

2. The three-prism projection display of claim 1, wherein said polarization beam splitter prism receives from said first dichroic beam splitter prism the first color component reflected by said first light modulator at said third side thereof, and receives from said second dichroic beam splitter prism the second and third color component reflected by said second and third light modulators at said fourth side thereof, said three-prism projection display further comprising a light polarization selector adapted to be disposed between said first side of said polarization beam splitter prism and the projection lens, said light polarization selector receiving the reflected first, second and third color components from said polarization beam splitter prism, and changing the polarization state of the reflected first color component from the first polarization state to the second polarization state.

3. Thethree-prismprojectiondisplayofclaim2, further comprising a polarizer adapted to be disposed between said light polarization selector and the projection lens, said polarizer being adapted to absorb light that has the first polarization state and to permit light that has the second polarization state to pass therethrough.

4. The three-prism projection display of claim 1, wherein said polarization state converting device includes:
a polarizer adapted to absorb light that has the second polarization state and to permit light that has the first polarization state to pass therethrough; and
a light polarization selector disposed between said polarizer and said second side of said polarization beam splitter prism so as to convert the polarization state of the first color component.
